(19) United States
(12) Patent Application Publication
(10) Pub. No.: US 2026/0349489 A1
(43) Pub. Date: Nov. 5, 2026

(54) EMBEDDED COMPUTING MODULE SWITCHING CIRCUIT, SUBSTRATE SYSTEM, AND SERVER

(71) Applicant: SUZHOU METABRAIN INTELLIGENT TECHNOLOGY CO., LTD., Suzhou, Jiangsu (CN)

(72) Inventors: Jingwei ZHANG, Suzhou, Jiangsu (CN); Sanxia CHEN, Suzhou, Jiangsu (CN); Tiejun LIU, Suzhou, Jiangsu (CN); Dafeng HAN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/113,195

(22) PCT Filed: Aug. 28, 2024
(86) PCT No.: PCT/CN2024/115230

§ 371 Date: Mar. 19, 2025

(30) Foreign Application Priority Data
Aug. 29, 2023 (CN) 202311093173.8

(51) Int. Cl. G06F 1/26

(52) U.S. Cl. CPC G06F 1/263

(57) ABSTRACT

An embedded computing module switching circuit, a substrate system, and a server are provided. The embedded computing module switching circuit includes: a first power conversion module and a trigger control module; an input end of the first power conversion module is electrically connected to a power supplying cable; a power output end of the first power conversion module is electrically connected to a power end of the embedded computing module; a power end of the trigger control module is electrically connected to a standby power supply cable; a first output end of the trigger control module is electrically connected to a power control line; and a second output end of the trigger control module is electrically connected to a start control port of the embedded computing module.

### CROSS-REFERENCE TO RELATED APPLICATIONS

The present disclosure is a national stage filing under 35 U.S.C. § 371 of international application number PCT/CN2024/115230, filed Aug. 28, 2024, which claims priority to Chinese Patent Application No. 202311093173.8, filed with the Patent Office on Aug. 29, 2023, and entitled “EMBEDDED COMPUTING MODULE SWITCHING CIRCUIT, SUBSTRATE SYSTEM, AND SERVER”, which is incorporated herein by reference in its entirety.

### TECHNICAL FIELD

The present disclosure relates to the technical field of computers, and in particular, to an embedded computing module switching circuit, a substrate system, and a server.

### BACKGROUND

An embedded computer-on-module express (COMe) is widely used in an embedded system design. COMe computer modules generally use standardized sizes and connectors to facilitate cooperation with different COMe substrates. The COMe computer module is a typical standard based on an X86 central processing unit (CPU) and its computer architecture structure. Control signals and input-output (IO) configurations of the COMe computer module are often bound to a control mode of an X86 computer.

With the continuous development of a computer technology, especially continuous deepening of artificial intelligence (AI) computation, new types of embedded computer-on-module continue to emerge. The embedded computer-on-module (referred to as heterogeneous computing module) is a system on a chip (SoC) that combines a general-purpose processor (which is usually an advanced RISC machine (ARM) architecture) and heterogeneous computation. An existing COMe X86 computer and an application thereof has a requirement for computing power upgrade, and these heterogeneous computing modules are different from the traditional X86 computer in terms of a power on control mode. As a result, there is a compatibility problem if a heterogeneous computing module is applied to the X86 computer.

### SUMMARY

For the problems in the related art, embodiments of the present disclosure provide an embedded computing module switching circuit, a substrate system, and a server.

In a first aspect, the present disclosure provides an embedded computing module switching circuit, including a first power conversion module and a trigger control module,
wherein an input end of the first power conversion module is electrically connected to a power supplying cable; a power output end of the first power conversion module is electrically connected to a power end of the embedded computing module;
a power end of the trigger control module is electrically connected to a standby power supply cable; a first output end of the trigger control module is electrically connected to a power control line;
a second output end of the trigger control module is electrically connected to a start control port of the embedded computing module;
the trigger control module is configured to:
output a power control signal to the first output end and output a start control signal to the second output end; by monitoring a power button trigger signal and monitoring a power supplying state of the first power conversion module, the power control signal is used for instructing a power supply to start to supply power or stops supplying power to the power supplying cable; and the start control signal is used for instructing the embedded computing module to start.

In an embodiment, according to the embedded computing module switching circuit provided by the present disclosure, the trigger control module includes a trigger signal monitoring submodule and a start control submodule;
an input end of the trigger signal monitoring submodule is electrically connected to a first end of a power button; a second end of the power button is grounded; an output end of the trigger signal monitoring submodule is electrically connected to an input end of the start control submodule; an output end of the start control submodule is electrically connected to the start control port of the embedded computing module;
the trigger signal monitoring submodule is configured to:
monitor the power button trigger signal; and
in a case that it is determined that the power button trigger signal indicates power on, output a power start control signal, wherein the power start control signal is used for instructing the power supply to start to supply power to the power supplying cable;
the start control submodule is configured to:
monitor the power supplying state of the first power conversion module; and
in a case that it is confirmed that the power start control signal has been received and the power supplying state of the first power conversion module is normal, output the start control signal, wherein the start control signal is used for instructing the embedded computing module to start.

In an embodiment, according to the embedded computing module switching circuit provided by the present disclosure, the trigger signal monitoring submodule includes: an inverter and a target flip-flop;
an input end of the inverter is electrically connected to a first end of the power button; an output end of the inverter is electrically connected to a first input end of the target flip-flop; a second input end of the target flip-flop is electrically connected to a power end of the target flip-flop; an output end of the target flip-flop is electrically connected to the input end of the start control submodule;
the target flip-flop is configured to: monitor a rising edge signal through the first input end, and output the power start control signal in a case that it is determined that the rising edge signal has been received; and a level of the power start control signal is the same as a level of the second input end of the target flip-flop.

In an embodiment, according to the embedded computing module switching circuit provided by the present disclosure, the trigger signal monitoring submodule further includes: a shutdown trigger signal monitoring unit; an input end of the shutdown trigger signal monitoring unit is electrically connected to the first end of the power button; an output end of the shutdown trigger signal monitoring unit is electrically connected to a clear end of the target flip-flop;
the shutdown trigger signal monitoring unit is configured to:
monitor the power button trigger signal; and
in a case that it is determined that the power button trigger signal indicates power off, output a clear control signal, wherein the clear control signal is used for indicating resetting on the output end of the target flip-flop; and
the target flip-flop is further configured to:
in a case that it is determined that the clear control signal has been received, output a power stop control signal, wherein a level of the power stop control signal is a ground level.

In an embodiment, according to the embedded computing module switching circuit provided by the present disclosure, the shutdown trigger signal monitoring unit includes: a low-pass filter and a Schmitt buffer;
an input end of the low-pass filter is electrically connected to the first end of the power button; an output end of the low-pass filter is electrically connected to an input end of the Schmitt buffer; and an output end of the Schmitt buffer is electrically connected to the clear end of the target flip-flop.

In an embodiment, according to the embedded computing module switching circuit provided by the present disclosure, the low-pass filter includes: a first resistor and a first capacitor;
a first end of the first resistor is electrically connected to the first end of the power button; a second end of the first resistor is electrically connected to a first end of the first capacitor and the input end of the Schmitt buffer; and a second end of the first capacitor is grounded.

In an embodiment, according to the embedded computing module switching circuit provided by the present disclosure, the clear end of the target flip-flop is electrically connected to a power-off control line, and the power-off control line is configured to transmit the clear control signal.

In an embodiment, according to the embedded computing module switching circuit provided by the present disclosure, the target flip-flop is a D flip-flop, and the D flip-flop is in a positive edge triggering mode.

In an embodiment, according to the embedded computing module switching circuit provided by the present disclosure, the start control submodule includes: a first AND gate unit and a second AND gate unit;
power supplying state indication ports of the first power supply conversion module are respectively electrically connected to corresponding input ends of the first AND gate unit, and one power supplying state indication port is configured to indicate a power supplying state of a supply voltage;
an output end of the first AND gate unit is electrically connected to a first input end of the second AND gate unit; a second input end of the second AND gate unit is electrically connected to an output end of the trigger signal monitoring submodule; an output end of the second AND gate unit is electrically connected to a start control port of the embedded computing module; a level of the power start control signal is used for representing logic 1;
the first power conversion module is configured to: in a case that power supplying of a target supply voltage is normal, instruct a port to output a logic high level through a target power supplying state, or in a case that the power supplying of the target supply voltage fails, instruct a port to output a logic low level through the target power supplying state;
the target supply voltage is any one of supply voltages supported by the first power conversion module; the logic high level is used for representing logic 1; and the logic low level is used for representing logic 0.

In an embodiment, according to the embedded computing module switching circuit provided by the present disclosure, the output end of the first AND gate unit is electrically connected to a power supplying state monitoring port of the embedded computing module.

In an embodiment, according to the embedded computing module switching circuit provided by the present disclosure, the trigger control module includes: a target micro control unit (MCU);
a first output end of the target micro control unit is electrically connected to the power control line; a second output end of the target micro control unit is electrically connected to the start control port of the embedded computing module;
the target micro control unit is configured to:
monitor the power button trigger signal and monitor the power supplying state of the first power conversion module;
in a case that it is determined that the power button trigger signal indicates power on, output a power start control signal to the power control line, wherein the power start control signal is used for instructing the power supply to start to supply power to the power supplying cable;
in a case that it is confirmed that the power start control signal has been received and the power supplying state of the first power conversion module is normal, output the start control signal to the embedded computing module, wherein the start control signal is used for instructing the embedded computing module to start.

In an embodiment, according to the embedded computing module switching circuit provided by the present disclosure, the first input end of the target micro control unit is electrically connected to a first end of the power button; a second end of the power button is grounded; and the target micro control unit is configured to:
monitor the power button trigger signal based on a level of the first end of the power button.

In an embodiment, according to the embedded computing module switching circuit provided by the present disclosure, power supplying state indication ports of the first power conversion module are respectively electrically connected to corresponding input ends of the target micro control unit, and one power supplying state indication port is configured to indicate a power supplying state of a supply voltage;
the first power conversion module is configured to: in a case that power supplying of a target supply voltage is normal, instruct a port to output a logic high level through a target power supplying state, or in a case that the power supplying of the target supply voltage fails, instruct a port to output a logic low level through the target power supplying state;
the target micro control unit is configured to:
monitor levels of the power supplying state indication ports, and monitor the power supplying state of the first power conversion module;
the target supply voltage is any one of supply voltages supported by the first power conversion module; the logic high level is used for representing logic 1; and the logic low level is used for representing logic 0.

In an embodiment, according to the embedded computing module switching circuit provided by the present disclosure, a third output end of the target micro control unit is electrically connected to a power supplying state monitoring port of the embedded computing module; and the target micro control unit is further configured to:
output a power supplying state indication signal to the embedded computing module, by monitoring the power supplying state of the first power conversion module.

In an embodiment, according to the embedded computing module switching circuit provided by the present disclosure, the target micro control unit is further configured to:
in a case that it is determined that the power button trigger signal indicates power off, output a power stop control signal through the first output end, wherein the power stop control signal is used for instructing the power supply to stop supplying power to the power supplying cable.

In an embodiment, according to the embedded computing module switching circuit provided by the present disclosure, a second input end of the target micro control unit is electrically connected to a power-off control line, and the target micro control unit is further configured to:
in a case that it is determined that the power-off control signal has been received, output a power stop control signal through the first output end, wherein the power stop control signal is used for instructing the power supply to stop supplying power to the power supplying cable.

In an embodiment, according to the embedded computing module switching circuit provided by the present disclosure, the trigger control module further includes: a linear voltage regulator, wherein the linear voltage regulator is configured to: step down a supply voltage on the standby power supply cable and provide a stepped-down supply voltage to a target load in the trigger control module.

In an embodiment, according to the embedded computing module switching circuit provided by the present disclosure, the trigger control module further includes: a trigger signal generation submodule, wherein the trigger signal generation submodule includes a power button, a second resistor, and a second capacitor;
a first end of the second resistor is electrically connected to the standby power supply cable; a second end of the second resistor is electrically connected to a first end of the power button and a first end of the second capacitor; and a second end of the power button and a second end of the second capacitor are grounded.

In an embodiment, according to the embedded computing module switching circuit provided by the present disclosure, the first power conversion module includes a plurality of direct-current power conversion units; the direct-current power conversion units are configured to: convert supply voltages on the power supplying cable and provide the converted supply voltages to the embedded computing module; and the converted supply voltages provided by different direct-current power conversion units are not the same.

In an embodiment, according to the embedded computing module switching circuit provided by the present disclosure, the embedded computing module switching circuit further includes: a second power conversion module, an input-output interface level conversion module, and an interface type conversion module,
wherein an input end of the second power conversion module is electrically connected to the power supplying cable; a power output end of the second power conversion module is electrically connected to the power end of the input-output interface level conversion module and a power end of the interface type conversion module;
a control port of the second power conversion module is electrically connected to an output end of the embedded computing module; and
the second power conversion module is configured to: receive, through the control port, a start indication signal transmitted by the embedded computing module, and in a case that the start indication signal has been received, start power supplying to the input-output interface level conversion module and the interface type conversion module.

In a second aspect, the present disclosure further provides an embedded computing module substrate system, including: a computing module substrate and any one of the above embedded computing module switching circuits.

In a third aspect, the present disclosure further provides a server, including: a power supply, an embedded computing module, and any one of the above embedded computing module substrate system.

The embedded computing module switching circuit, the substrate system, and the server provided in the present disclosure can generate a power control signal corresponding to a power button trigger signal by using the trigger control module to monitor the power button trigger signal (a heterogeneous computing module does not output a power control signal). In a case that the power button trigger signal indicates power on, the corresponding power control signal can be transmitted through the power control line to control the power supply to start to supply power to the power supplying cable. The first power conversion module can then convert a voltage on the power supplying cable and provide a converted voltage to the embedded computing module, and then by monitoring a power supplying state of the first power conversion module, the trigger control module can generate a corresponding start control signal in a case that the power supplying state of the first power conversion module is normal, to drive the embedded computing module to start, so that a power on control mode for an X86 computer can be compatible with a heterogeneous computing module.

### BRIEF DESCRIPTION OF THE DRAWINGS

To describe the technical solutions in the present disclosure or in the related art more clearly, the following briefly introduces the accompanying drawings for describing the embodiments or the related art. Apparently, the accompanying drawings in the following description show some embodiments of the present disclosure, and a person of ordinary skill in the art may still derive other drawings from the accompanying drawings without creative efforts.

FIG. 1 is a flowchart of a COMe module power on process based on X86 in the related art;

FIG. 2 is a schematic structural diagram I of an embedded computing module switching circuit according to the present disclosure;

FIG. 3 is a schematic structural diagram II of an embedded computing module switching circuit according to the present disclosure;

FIG. 4 is a schematic structural diagram I of a trigger control module according to the present disclosure;

FIG. 5 is a schematic structural diagram II of a trigger control module according to the present disclosure;

FIG. 6 is a schematic structural diagram III of an embedded computing module switching circuit according to the present disclosure;

FIG. 7 is a flowchart of power on and power off of a COMe substrate system according to the present disclosure;

FIG. 8 is a power on start sequence chart according to the present disclosure;

FIG. 9 is a schematic structural diagram III of a trigger control module according to the present disclosure;

FIG. 10 is a schematic structural diagram of an embedded computing module substrate system according to the present disclosure; and

FIG. 11 is a schematic structural diagram of a server according to the present disclosure.

### NUMERALS IN THE DRAWINGS

10: first power conversion module; 20: trigger control module; 21: trigger signal monitoring submodule; 211: shutdown trigger signal monitoring unit; 212: low-pass filter; 22: start control submodule; 23: trigger signal generation submodule; 30: COMe substrate; 40: embedded computing module; 50: second power conversion module; 60 input-output interface level conversion module; and 70: interface type conversion module.

### DETAILED DESCRIPTION OF THE EMBODIMENTS

For ease of understanding the embodiments of the present disclosure more clearly, some relevant background knowledge is first described below.

The COMe computer module is a typical standard based on an X86 CPU and its computer architecture structure. Control signals and IO configurations of the COMe computer module are often bound to a control mode of an X86 computer. Most of these control signals are from a southbridge of the X86 computer. Even if based on an X86 SoC or using a platform controller hub (PCH), there is still the concept of a southbridge for a computer platform, including a power on and clear mode, a peripheral management mechanism based on a peripheral component interconnect express (PCIe) bus, and a module control bus, which are typical X86 computer platform standards.

For power on control of a COMe module of a traditional X86 computer, in the COMe, a power on procedure between a substrate and the module is mainly adjusted to adjust the computer from state S5 to state S0 through interaction of signal states. These states are all working states in an advanced configuration and power management interface (ACPI) standard. FIG. 1 is a flowchart of a COMe module power on process based on X86 in the related art. As shown in FIG. 1, under a COMe, power on control logics of a substrate and a COMe computer module cooperate with each other, generally using the following mode:

In state S5 of a power supply, a 5V Stand by is output to the COMe computer module through the substrate, and control circuits related to a power button trigger signal (PWRBTN #) of the module are all in a standby power supply region. When signal PWRBTN # is triggered, the computer can be awakened from state S5, enter state S4, and then enter state S3.

Before entering state S0 (normal operation), it is important to set an advanced technology extended (ATX) power supply on-off control signal pin (power supply on #, PSON #) control signal pin of the computer to “low”, that is, to perform an action of turning on an ATX power supply. In this specification, it is recommended to use an S3 signal (pulled low) to indirectly turn on the power supply.

In the related art, after the S3 signal is processed, PSON # is driven. Or, the power on logic (e.g. complex programmable logic device (CPLD) can be used on the substrate to determine state conditions of a plurality of signals (including PWRBTN #, S3) to ultimately control PSON #.

In the COMe, main control power on signals is as shown in Table 1.

TABLE 1
Table of main power on signals of the COMe module

| Signal | Function | Remarks |
|---|---|---|
| PWRBTN# | This is a signal indicating that a | |
| (input to the COMe module) | falling effect triggering a low level | |
| | being valid, which can awake the | |
| | computer from state S5 | |
| PWR_OK | This state signal indicates by the | |
| (input to the COMe module) | external ATX power supply that | |
| | power outputting of the power | |
| | supply module has been normal | |
| SUS_STAT# | This signal reflects that the module | |
| (COMe module output) | is to enter a low-power state | |
| US_S3# | Signal S3 indicates that the module | This signal can be used for |
| (COMe module output) | is to be in a dormancy state S3 | controlling the ATX power |
| | | supply to be on (by controlling |
| | | PSON#) |
| SUS_S4# | Signal S4 indicates that the module | |
| (COMe module output) | is to be in a dormancy state S4 | |
| SUS_S5# | Signal S5 indicates that the module | |
| (COMe module output) | is to be in a dormancy state S5 | |

However, a heterogeneous computing module cannot match the above power on and control modes, mainly because: (1) Such an SoC does not output definitions of signals of relevant states of ACPI. (2) Power supplied to such an SoC does not fully satisfy two kinds of power supplies: a 5V Stand by and a 12V power supply requirements of the COMe module. (3) Most of these modules need to be powered on first, and then the switching circuit or a substrate IO is notified to be powered on.

In order to overcome the above shortcomings, the present disclosure provides an embedded computing module switching circuit, a substrate system, and a server. Through the switching circuit, a power on control mode for an X86 computer can be compatible with a heterogeneous computing module.

In order to make the objectives, technical solutions, and advantages of the present disclosure clearer, the technical solutions in the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

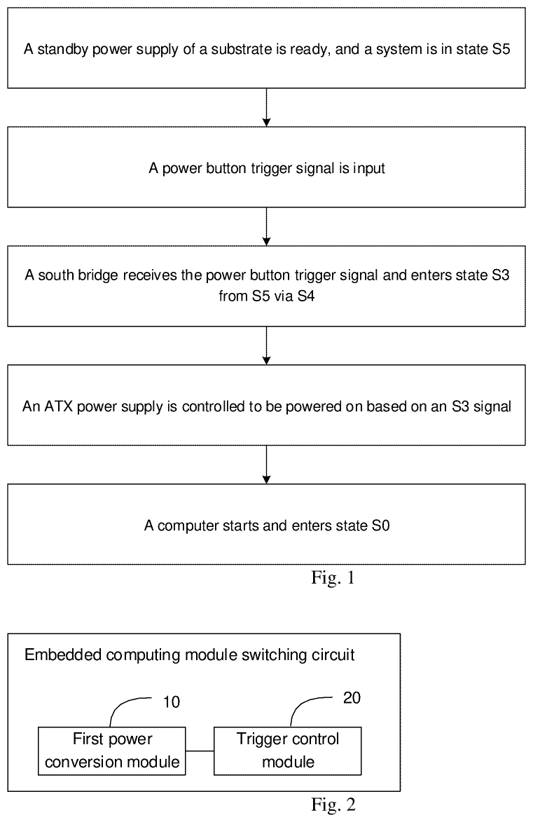

FIG. 2 is a schematic structural diagram I of an embedded computing module switching circuit according to the present disclosure. As shown in FIG. 2, the embedded computing module switching circuit includes: a first power conversion module 10 and a trigger control module 20.

An input end of the first power conversion module is electrically connected to a power supplying cable. A power output end of the first power conversion module is electrically connected to a power end of the embedded computing module.

A power end of the trigger control module is electrically connected to a standby power supply cable. A first output end of the trigger control module is electrically connected to a power control line. A second output end of the trigger control module is electrically connected to a start control port of the embedded computing module.

The trigger control module is configured to:
output a power control signal to the first output end and output a start control signal to the second output end, by monitoring a power button trigger signal and monitoring a power supplying state of the first power conversion module. The power control signal is used for instructing a power supply to start to supply power or stops supplying power to the power supplying cable. The start control signal is used for instructing the embedded computing module to start.

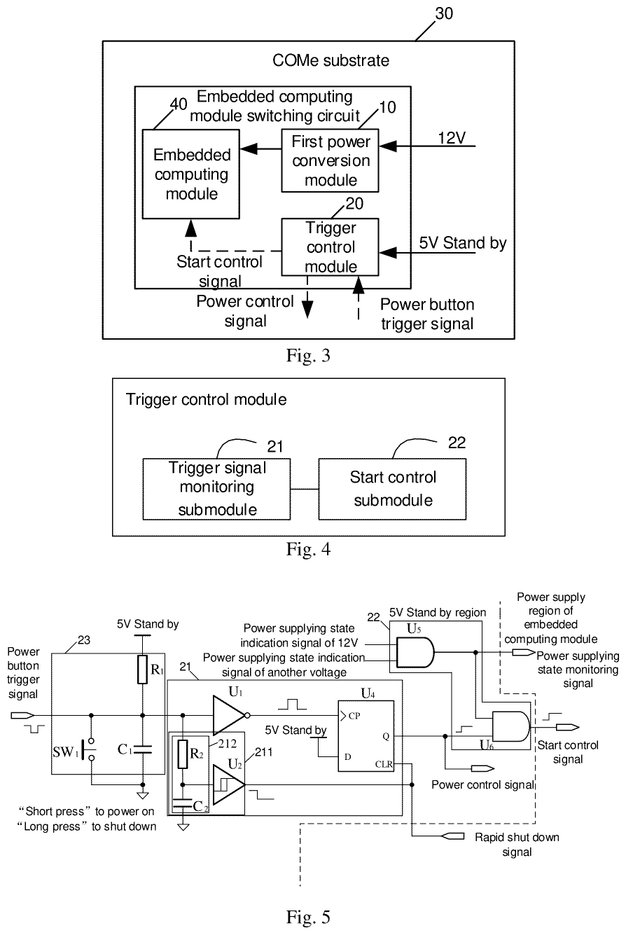

In an embodiment, FIG. 3 is a schematic structural diagram II of an embedded computing module switching circuit according to the present disclosure. As shown in FIG. 3, solid arrows in FIG. 3 represent power supplying paths, and dashed arrows in FIG. 3 represent control signal paths. An input end of the first power conversion module is electrically connected to a power supplying cable (such as a 12V power supplying cable in FIG. 3) of a COMe substrate 30 (i.e. a computing module substrate), and a power output end of the first power conversion module is electrically connected to a power end of the embedded computing module 40. A power end of the trigger control module is electrically connected to a standby power supply cable (such as a 5V standby power supply cable in FIG. 3) of the COMe substrate. A first output end of the trigger control module is connected to a power control line of the COMe substrate, and the power control line can be configured to transmit a power control signal (such as S3 # signal). A second output end of the trigger control module is electrically connected to a start control port of the embedded computing module. The embedded computing module can be a heterogeneous computing module (such as an SoC module).

For “circuit” in the present disclosure, a circuit may be an electronic system composed of electronic elements (such as a resistor, a capacitor, an inductor, and a transistor) and wire connections. The circuit can be configured to perform specific functions such as signal amplification, signal processing, and logical operation. The circuit transfers electrical energy between the elements through current and voltage.

For “module” in the present disclosure, in a circuit design, a module can be a relatively independent functional unit, and is typically composed of a plurality of electronic elements to achieve a specific function. A module may be a sub circuit or a subsystem that can be connected to other modules through input and output interfaces.

For “unit” in the present disclosure, in a circuit design, a unit is usually composed of one or more electronic elements, or may be a logic unit, which can be a basic component for building a module. The unit may be a resistor, a capacitor, a transistor, a gate circuit, etc.

It can be understood that, as shown in FIG. 3, in order to match a COMe interface and meet structural requirements, an embedded computing module switching circuit (or referred to as a COMe switching circuit) can be designed between an embedded computing module (such as an SoC module) and an existing system substrate. The trigger control module in the COMe switching circuit can monitor a power button trigger signal (i.e. a PWRBTN # signal) and monitor a power supplying state of the first power conversion module. In a case that the power button trigger signal indicates power on, the corresponding power control signal can be transmitted through the power control line of the computer substrate to control a power supply to start to supply power to the power supplying cable. The first power conversion module can then convert a voltage on the power supplying cable and provide a converted voltage to the embedded computing module, and then by monitoring the power supplying state of the first power conversion module, the trigger control module can generate a corresponding start control signal in a case that the power supplying state of the first power conversion module is normal, to drive the embedded computing module to start, so that update and computing power improvement of a core module of a system can be achieved without changing an original computing module substrate.

It can be understood that the trigger control module is in a standby power supply region of the system, such as a 5V Stand by in the COMe, which is input to the power end of the trigger control module according to a standard pin, and the trigger control module is in the 5V standby power supply region of the system.

In an embodiment, in a case that a supply voltage required by the embedded computing module is a voltage provided by the power supplying cable, the first power conversion module may be a conductive connector to conductively connect the power supplying cable to the power end of the embedded computing module.

In an embodiment, in a case that the supply voltage required by the embedded computing module is not a voltage provided by the power supplying cable, the first power conversion module can convert the supply voltage on the power supplying cable, to enable the converted supply voltage to adapt to the embedded computing module.

In an embodiment, in a case that the embedded computing module requires various supply voltages, such as the voltage provided by the power supplying cable and other supply voltages, the first power conversion module can lead the power supplying cable to a corresponding power port on the embedded computing module, convert the supply voltage on the power supplying cable, and provide the converted supply voltage to the corresponding power port on the embedded computing module.

Therefore, a power control signal corresponding to a power button trigger signal can be generated by using the trigger control module to monitor the power button trigger signal (a heterogeneous computing module does not output a power control signal). In a case that the power button trigger signal indicates power on, the corresponding power control signal can be transmitted through the power control line of the computing module substrate to control the power supply to start to supply power to the power supplying cable. The first power conversion module can then convert a voltage on the power supplying cable and provide a converted voltage to the embedded computing module, and then by monitoring a power supplying state of the first power conversion module, the trigger control module can generate a corresponding start control signal in a case that the power supplying state of the first power conversion module is normal, to drive the embedded computing module to start, so that a power on control mode of an X86 computer can be compatible with a heterogeneous computing module.

In an embodiment, according to the embedded computing module switching circuit provided by the present disclosure, the trigger control module includes a trigger signal monitoring submodule and a start control submodule.

An input end of the trigger signal monitoring submodule is electrically connected to a first end of a power button; a second end of the power button is grounded. An output end of the trigger signal monitoring submodule is electrically connected to an input end of the start control submodule. An output end of the start control submodule is electrically connected to the start control port of the embedded computing module.

The trigger signal monitoring submodule is configured to:
monitor the power button trigger signal; and
in a case that it is determined that the power button trigger signal indicates power on, output a power start control signal, wherein the power start control signal is used for instructing the power supply to start to supply power to the power supplying cable.

The start control submodule is configured to:
monitor the power supplying state of the first power conversion module; and
in a case that it is confirmed that the power start control signal has been received and the power supplying state of the first power conversion module is normal, output the start control signal, wherein the start control signal is used for instructing the embedded computing module to start.

In an embodiment, FIG. 4 is a schematic structural diagram I of a trigger control module according to the present disclosure. As shown in FIG. 4, the trigger control module includes a trigger signal monitoring submodule 21 and a start control submodule 22. The trigger signal monitoring submodule can monitor a power button trigger signal and determine whether the power button trigger signal (a PWRBTN # signal) indicates power on. If it is determined that the PWRBTN # signal indicates power on, a power start control signal is output to control a power supply to start to supply power to the power supplying cable. The first power conversion module can then convert a voltage on the power supplying cable and provide a converted voltage to the embedded computing module. The start control submodule can monitor a power supplying state of the first power conversion module, and then can output a start control signal in a case that the power supplying state of the first power conversion module is normal, to drive the embedded computing module to start, so that an X86 computer can be compatible with a heterogeneous computing module.

In an embodiment, according to the embedded computing module switching circuit provided by the present disclosure, the trigger signal monitoring submodule includes: an inverter and a target flip-flop.

An input end of the inverter is electrically connected to a first end of the power button. An output end of the inverter is electrically connected to a first input end of the target flip-flop. A second input end of the target flip-flop is electrically connected to a power end of the target flip-flop. An output end of the target flip-flop is electrically connected to the input end of the start control submodule.

The target flip-flop is configured to: monitor a rising edge signal through the first input end, and output the power start control signal in a case that it is determined that the rising edge signal has been received. A level of the power start control signal is the same as a level of the second input end of the target flip-flop.

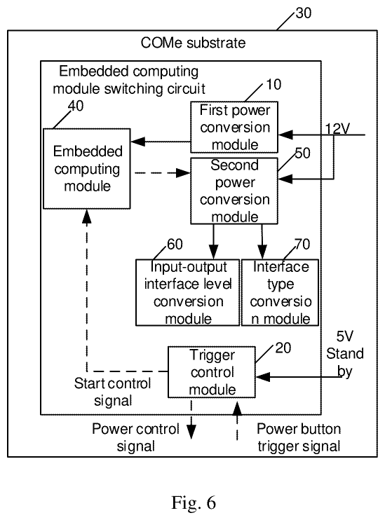

FIG. 5 is a schematic structural diagram II of a trigger control module according to the present disclosure. As shown in FIG. 5, the trigger signal monitoring submodule includes an inverter (e.g. U1 in FIG. 5) and a target flip-flop (e.g. U4 in FIG. 5). An output end of U1 is electrically connected to a first input end (e.g. a CP port of U4 in FIG. 5) of U4, and a second input end (e.g. a D port of U4 in FIG. 5) of U4 is electrically connected to a power end of U4. When a PWRBTN # signal is a trigger signal with an order of magnitude of hundreds of milliseconds (ms) (i.e. the PWRBTN # signal indicates power on), a low-level pulse is converted into a positive high-level pulse by the inverter U1. The target flip-flop can then monitor a rising edge signal through the first input end, and transmit the level of the second input end of the target flip-flop to the output end of the target flip-flop, so that the level of the output end is the same as the level of the second input end. Since the second input end of the target flip-flop is electrically connected to the power end of the target flip-flop, in a case that the PWRBTN # signal indicates power on, the target flip-flop can output a logic high level (i.e. a power start control signal) as power supplying enable for a substrate, to instruct a power supply to start to supply power to the power supplying cable.

In an embodiment, according to the embedded computing module switching circuit provided by the present disclosure, the trigger signal monitoring submodule further includes: a shutdown trigger signal monitoring unit. An input end of the shutdown trigger signal monitoring unit is electrically connected to the first end of the power button. An output end of the shutdown trigger signal monitoring unit is electrically connected to a clear end of the target flip-flop.

The shutdown trigger signal monitoring unit is configured to:
monitor the power button trigger signal; and
in a case that it is determined that the power button trigger signal indicates power off, output a clear control signal, wherein the clear control signal is used for indicating resetting on the output end of the target flip-flop.

The target flip-flop is further configured to:
in a case that it is determined that the clear control signal has been received, output a power stop control signal, wherein a level of the power stop control signal is a ground level.

In an embodiment, as shown in FIG. 5, the trigger signal monitoring submodule further includes a shutdown trigger signal monitoring unit 211. The shutdown trigger signal submodule can monitor a power button trigger signal (a PWRBTN # signal) and determine whether the PWRBTN # signal indicates power off. In a case that it is determined that the PWRBTN # signal indicates power off, a clear control signal (such as a logic low level) can be output to a clear end (such as a CLR port of U4 in FIG. 5) of the target flip-flop. The target flip-flop (such as U4 in FIG. 5) can determine whether a clear control signal has been received. In a case that it is determined that the clear control signal has been received, a power stop control signal is output. A level of the power stop control signal is a ground level, which instructs, through the logic low level, a power supply to stop supply power to the power supplying cable, thus driving the embedded computing module to stop operation. A shutdown control mode for an X86 computer can be compatible with a heterogeneous computing module.

In an embodiment, according to the embedded computing module switching circuit provided by the present disclosure, the shutdown trigger signal monitoring unit includes: a low-pass filter and a Schmitt buffer.

An input end of the low-pass filter is electrically connected to the first end of the power button. An output end of the low-pass filter is electrically connected to an input end of the Schmitt buffer. An output end of the Schmitt buffer is electrically connected to the clear end of the target flip-flop.

In an embodiment, as shown in FIG. 5, the shutdown trigger signal monitoring unit includes a low-pass filter 212 and a Schmitt buffer (U2 in FIG. 5). When PWRBTN # is a trigger signal with an order of magnitude of hundreds of milliseconds (ms), the low-pass filter filters out the trigger pulse signal and does not clear the target flip-flop. When PWRBTN # is a low-level signal with an order of magnitude of seconds(s), an output of U2 is normally “low”, so that an output of the target flip-flop (such as U4 in FIG. 5) is 0, so that a long press is made to a button to forcibly make the system in a power off state.

In an embodiment, according to the embedded computing module switching circuit provided by the present disclosure, the low-pass filter includes: a first resistor and a first capacitor.

A first end of the first resistor is electrically connected to the first end of the power button. A second end of the first resistor is electrically connected to a first end of the first capacitor and the input end of the Schmitt buffer. A second end of the first capacitor is grounded.

In an embodiment, as shown in FIG. 5, the first resistor (such as a resistor R2 in FIG. 5) and the first capacitor (such as a capacitor C2 in FIG. 5) form the low-pass filter, and U2 is a buffer with Schmitt characteristics. When the PWRBTN # is the trigger signal with the order of magnitude of hundreds of milliseconds (ms) (namely, a signal generated by a short press made to SW1 in FIG. 5 and indicating power on), the low-level pulse is converted into a positive high-level pulse by the inverter U1, and the D flip-flop is set. In this case, the low-pass filter composed of R2 and C2 filters out the trigger pulse signal and does not clear the D flip-flop. When PWRBTN # is a low-level signal with an order of magnitude of seconds(s) (namely, a signal generated by a long press made to SW1 in FIG. 5 and indicating power off), an output of U2 is normally “low”, so that an output of the target flip-flop (such as U4 in FIG. 5) is 0, so that a long press is made to a button to forcibly make the system in a power off state.

In an embodiment, according to the embedded computing module switching circuit provided by the present disclosure, the clear end of the target flip-flop is electrically connected to a power-off control line, and the power-off control line is configured to transmit the clear control signal.

In an embodiment, a COMe signal also uses a rapid shut down signal (the clear control signal shown in FIG. 5 can be a Rapid shut down signal) to urgently power off the module. This signal can be connected to a clear pin of the target flip-flop (such as the CLR port of U4 in FIG. 5).

In an embodiment, the power off control line can be led out through a computing module substrate (i.e. a COMe substrate), and the clear end of the target flip-flop is electrically connected to the power-off control line of the computing module substrate.

In an embodiment, according to the embedded computing module switching circuit provided by the present disclosure, the target flip-flop is a D flip-flop, and the D flip-flop is in a positive edge triggering mode.

In an embodiment, as shown in FIG. 5, since the heterogeneous computing module no longer outputs an S3 signal, a control logic based on the D flip-flop (such as U4 in FIG. 5) is designed to convert a trigger pulse of a button trigger signal (PWRBTN #) into the power start control signal (also referred to as a substrate power supplying enabling signal, which is a pseudo S3 signal). The original COMe substrate can convert the power start control signal and output the S3 signal, which inherits an original ATX power supply to control a 12V power supply to be turned on.

In an embodiment, according to the embedded computing module switching circuit provided by the present disclosure, the start control submodule includes: a first AND gate unit and a second AND gate unit.

Power supplying state indication ports of the first power supply conversion module are respectively electrically connected to corresponding input ends of the first AND gate unit, and one power supplying state indication port is configured to indicate a power supplying state of a supply voltage.

An output end of the first AND gate unit is electrically connected to a first input end of the second AND gate unit. A second input end of the second AND gate unit is electrically connected to an output end of the trigger signal monitoring submodule. An output end of the second AND gate unit is electrically connected to a start control port of the embedded computing module. A level of the power start control signal is used for representing logic 1.

The first power conversion module is configured to: in a case that power supplying of a target supply voltage is normal, instruct a port to output a logic high level through a target power supplying state, or in a case that the power supplying of the target supply voltage fails, instruct a port to output a logic low level through the target power supplying state.

The target supply voltage is any one of supply voltages supported by the first power conversion module. The logic high level is used for representing logic 1. The logic low level is used for representing logic 0.

In an embodiment, as shown in FIG. 5, the start control submodule includes a first AND gate unit (such as U5 in FIG. 5) and a second AND gate unit (such as U6 in FIG. 5). According to the design of the circuit, the first AND gate unit monitors a power supplying condition of the first power supply conversion module and monitor the power supplying states of the supply voltages of the first power supply conversion module. The first power supply conversion module can output a power supplying state indication signal (POWER GOOD signal) at a logic high level through a target power supplying state indication port in a case that a target supply voltage (such as a 12V supply voltage) is normally supplied, or output a power supplying state indication signal with a logic low level through a target power supplying state indication port in a case that supplying of a target supply voltage fails. In a case that the power supplying states of the supply voltages of the first power supply conversion module are normal, the power supplying state indication ports of the first power conversion module output logic high levels, and then the first AND gate unit outputs a logic high level. If the second AND gate unit receives the logic high level output by the first AND gate unit and the power start control signal (a level of which is used for representing logic 1) output by the trigger signal monitoring submodule, the second AND gate unit outputs a logic high level (serving as a start control signal), to drive the embedded computing module to start.

In an embodiment, according to the embedded computing module switching circuit provided by the present disclosure, the output end of the first AND gate unit is electrically connected to a power supplying state monitoring port of the embedded computing module.

In an embodiment, as shown in FIG. 5, an output end (which outputs a power supplying state monitoring signal) of U5 can be electrically connected to a power supplying state monitoring port of the embedded computing module, so that the embedded computing module obtains the power supplying state of the first power conversion module.

In an embodiment, according to the embedded computing module switching circuit provided by the present disclosure, the trigger control module includes: a target micro control unit (MCU).

A first output end of the target micro control unit is electrically connected to the power control line. A second output end of the target micro control unit is electrically connected to the start control port of the embedded computing module.

The micro control unit is configured to:
monitor the power button trigger signal and monitor the power supplying state of the first power conversion module;
in a case that it is determined that the power button trigger signal indicates power on, output a power start control signal to the power control line, wherein the power start control signal is used for instructing the power supply to start to supply power to the power supplying cable.
in a case that it is confirmed that the power start control signal has been received and the power supplying state of the first power conversion module is normal, output the start control signal to the embedded computing module, wherein the start control signal is used for instructing the embedded computing module to start.

In an embodiment, the target micro control unit can determine whether the power button trigger signal (a PWRBTN # signal) indicates power on. In a case that it is determined that the PWRBTN #signal indicates power on, a power start control signal is output to control a power supply to start to supply power to the power supplying cable. The first power conversion module can then convert a voltage on the power supplying cable and provide a converted voltage to the embedded computing module. The target micro control unit can further monitor a power supplying state of the first power conversion module, and then can output a start control signal in a case that the power supplying state of the first power conversion module is normal, to drive the embedded computing module to start, so that an X86 computer can be compatible with a heterogeneous computing module.

In an embodiment, the trigger control module includes a target micro control unit, the foregoing trigger signal monitoring submodule, the foregoing start control submodule, a first switch module, and a second switch module. A first end of the first switch module is electrically connected to a standby power supply cable, and a second end of the first switch module is electrically connected to a power end of the target micro control unit. In a case that the first switch module is in a conducted state, the first end and second end of the first switch module are conducted to each other. In a case that the first switch module is in an open circuit state, the first end and second end of the first switch module are not conducted to each other. A first end of the second switch module is electrically connected to the standby power supply cable, and a second end of the second switch module is electrically connected to a power end of the trigger signal monitoring submodule and a power end of the start control submodule. In a case that the second switch module is in a conducted state, the first end and second end of the second switch module are conducted to each other. In a case that the second switch module is in an open circuit state, the first end and second end of the second switch module are not conducted to each other.

Thus, the target micro control unit can be driven to operate by controlling the first switch module to be in the conducted state and the second switch module to be in the open circuit state, that is, by controlling the trigger control module to be in a first working mode. In a case that the target micro control unit fails, the trigger signal monitoring submodule and the start control submodule can be driven to operate by controlling the first switch module to be in the open circuit state and the second switch module to be in the conducted state, namely, controlling the trigger control module to be in a second working mode. By switching between the two working models, in a case that the circuit in one working mode fails, the circuit in the other working mode ensures that the function of the trigger control module is normal, thereby improving the stability of the circuit.

In an embodiment, according to the embedded computing module switching circuit provided by the present disclosure, the first input end of the target micro control unit is electrically connected to a first end of the power button. A second end of the power button is grounded. The target micro control unit is configured to:
monitor the power button trigger signal based on a level of the first end of the power button.

In an embodiment, the power button trigger signal (PWRBTN # signal) is a low-level pulse signal, and the target micro control unit can periodically measure and record the level of the first end of the power button to monitor the PWRBTN # signal.

In an embodiment, according to the embedded computing module switching circuit provided by the present disclosure, power supplying state indication ports of the first power conversion module are respectively electrically connected to corresponding input ends of the target micro control unit, and one power supplying state indication port is configured to indicate a power supplying state of a supply voltage.

The first power conversion module is configured to: in a case that power supplying of a target supply voltage is normal, instruct a port to output a logic high level through a target power supplying state, or in a case that the power supplying of the target supply voltage fails, instruct a port to output a logic low level through the target power supplying state.

The target micro control unit is configured to:
monitor levels of the power supplying state indication ports, and monitor the power supplying state of the first power conversion module.

The target supply voltage is any one of supply voltages supported by the first power conversion module. The logic high level is used for representing logic 1. The logic low level is used for representing logic 0.

In an embodiment, the first power conversion module can instruct a port to output a logic high level (POWER GOOD signal), through a target power supplying state in a case that power supplying of a target supply voltage is normal, or instruct a port to output a logic low level, through the target power supplying state in a case that the power supplying of the target supply voltage fails. When the power supplying states of the supply voltages of the first power supply conversion module are normal, the power supplying state indication ports of the first power supply conversion module output logic high levels. Therefore, in a case that it is monitored that the power supplying state indication ports all output the logic high levels, the target micro control unit can determine that the power supplying state of the first power supply conversion module is normal.

In an embodiment, according to the embedded computing module switching circuit provided by the present disclosure, a third output end of the target micro control unit is electrically connected to a power supplying state monitoring port of the embedded computing module. The target micro control unit is further configured to:
output a power supplying state indication signal to the embedded computing module, by monitoring the power supplying state of the first power conversion module.

In an embodiment, the target micro control unit can output power supplying state monitoring information to the embedded computing module through a third output end, so that the embedded computing module obtains the power supplying state of the first power conversion module.

In an embodiment, according to the embedded computing module switching circuit provided by the present disclosure, the target micro control unit is further configured to:
in a case that it is determined that the power button trigger signal indicates shutdown, output a power stop control signal through the first output end, wherein the power stop control signal is used for instructing the power supply to stop supplying power to the power supplying cable.

In an embodiment, the target micro control unit can determine, in a case that the power button trigger signal has been monitored, whether the power button trigger signal indicates shutdown; and in a case that it is determined that the power button trigger signal indicates shutdown, output a power stop control signal through the first output end to instruct the power supply to stop supplying power to the power supplying cable, thereby driving the embedded computing module to stop operation, so that the shutdown control mode for an X86 computer can be compatible with a heterogeneous computing module.

In an embodiment, according to the embedded computing module switching circuit provided by the present disclosure, a second input end of the target micro control unit is electrically connected to a power-off control line. The target micro control unit is further configured to:
in a case that it is determined that the power-off control signal has been received, output a power stop control signal through the first output end, wherein the power stop control signal is used for instructing the power supply to stop supplying power to the power supplying cable.

In an embodiment, the COMe standard signal also uses a Rapid shutdown signal. The power-off control signal can be a Rapid shutdown signal. In a case that it is determined that the Rapid shutdown signal has been received, a power stop control signal can be output through the first output end, to instruct the power supply to stop supplying power to the power supplying cable, thereby driving the embedded computing module to stop operation, so that the rapid shutdown control mode for an X86 computer can be compatible with a heterogeneous computing module.

In an embodiment, according to the embedded computing module switching circuit provided by the present disclosure, the trigger control module further includes: a linear voltage regulator, wherein the linear voltage regulator is configured to: step down a supply voltage on the standby power supply cable and provide a stepped-down supply voltage to a target load in the trigger control module.

In an embodiment, as shown in FIG. 5, a standby power supply region is shown on the left hand side of the dashed line. When a 5V Standby is used to supply power to the switching circuit, or a 3.3V level is required in a control logic, a low dropout regulator (LDO) is used to convert the 5V Stand by to a 3.3V Stand by. This standby power supply region is separated from power of the embedded computing module and other power supplies of the switching circuit. Signals on the right hand side of the dashed line belong to a power region of the embedded computing module. A signal between the standby power supply region and the power region of the embedded computing module is isolated.

In an embodiment, according to the embedded computing module switching circuit provided by the present disclosure, the trigger control module further includes: a trigger signal generation submodule, wherein the trigger signal generation submodule includes a power button, a second resistor, and a second capacitor.

A first end of the second resistor is electrically connected to the standby power supply cable. A second end of the second resistor is electrically connected to a first end of the power button and a first end of the second capacitor. A second end of the power button and a second end of the second capacitor are grounded.

In an embodiment, as shown in FIG. 5, the trigger signal generation submodule 23 includes a power button (such as button SW1 in FIG. 5), a second resistor (such as resistor R1 in FIG. 5), and a second capacitor (such as capacitor C1 in FIG. 5).

In an embodiment, according to the embedded computing module switching circuit provided by the present disclosure, the first power conversion module includes a plurality of direct-current power conversion units. The direct-current power conversion units are configured to: convert supply voltages on the power supplying cable and provide the converted supply voltages to the embedded computing module. The converted supply voltages provided by different direct-current power conversion units are not the same.

It can be understood that 12V power required by the embedded computing module can be input by a system, and other desired supply voltages can be achieved through the first power conversion module on the switching circuit.

For example, the power required by the embedded computing module includes 12V power, 5V power, and 3.3V power. A direct current power conversion unit can convert the 12V power into the 5V power and provide the 5V power to the embedded computing module, and another direct current power conversion unit can convert the 12V power into the 3.3V power and provide the 3.3V power to the embedded computing module.

In an embodiment, according to the embedded computing module switching circuit provided by the present disclosure, the embedded computing module switching circuit further includes: a second power conversion module, an input-output interface level conversion module, and an interface type conversion module.

An input end of the second power conversion module is electrically connected to the power supplying cable. A power output end of the second power conversion module is electrically connected to the power end of the input-output interface level conversion module and a power end of the interface type conversion module.

A control port of the second power conversion module is electrically connected to an output end of the embedded computing module.

The second power conversion module is configured to: receive, through the control port, a start indication signal transmitted by the embedded computing module, and in a case that the start indication signal has been received, start power supplying to the input-output interface level conversion module and the interface type conversion module.

In an embodiment, FIG. 6 is a schematic structural diagram III of an embedded computing module switching circuit according to the present disclosure. As shown in FIG. 6, solid arrows in FIG. 6 represent power supplying paths, and dashed arrows in FIG. 6 represent control signal paths. The embedded computing module switching circuit further includes a second power conversion module 50, an input-output interface level conversion module 60, and an interface type conversion module 70. The input-output interface level conversion module is configured to convert a level of an input-output (IO) interface of the embedded computing module switching circuit, and the interface type conversion module is configured to convert an interface type of the embedded computing module switching circuit.

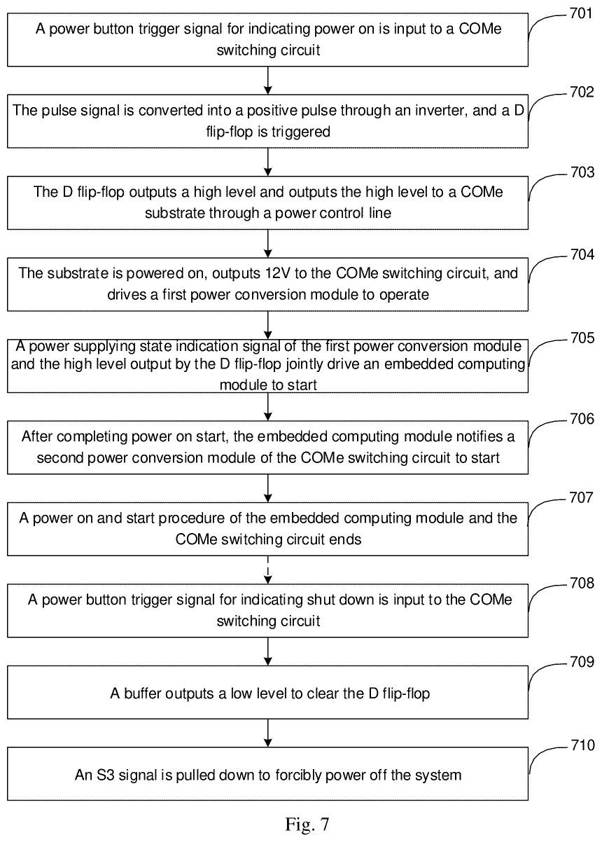

FIG. 7 is a flowchart of power on and power off of a COMe substrate system according to the present disclosure. A COMe switching circuit can use the trigger control module shown in FIG. 5. In this case, as shown in FIG. 7, power on and power off procedures of the COMe substrate system includes step 701 to step 710. Step 701 to step 707 represent a power on procedure of the COMe substrate system, and step 708 to step 710 represent a power off procedure of the COMe substrate system.
Step 701: A power button trigger signal (which is a PWRBTN #pulse signal, in an order of magnitude of hundreds of milliseconds) for indicating power on is input to the COMe switching circuit.
Step 702: The pulse signal is converted into a positive pulse through an inverter, and the D flip-flop is triggered.
Step 703: The D flip-flop outputs a high level and outputs the high level to a COMe substrate through a power control line (configured as a line for transmitting an S3 signal).
Step 704: The substrate is powered on, outputs 12V to the COMe switching circuit, and drives the first power conversion module to operate.
Step 705: A power supplying state indication signal (a POWER GOOD signal) of the first power conversion module and the high level output by the D flip-flop jointly drive the embedded computing module to start.
Step 706: After completing power on start, the embedded computing module notifies the second power conversion module of the COMe switching circuit to start.
Step 707: The power on and start procedure of the embedded computing module and the COMe switching circuit ends.
Step 708: A power button trigger signal (which is a PWRBTN #pulse signal, in an order of magnitude of seconds) for indicating shutdown is input to the COMe switching circuit.
Step 709: The buffer outputs a low level to clear the D flip-flop.
Step 710: An S3 signal is pulled down to forcibly power off the system.

It can be understood that the embedded computing module can be a heterogeneous computing module. For step 706 in FIG. 7, the reason why the heterogeneous computing module is powered on first and then an external DC module is notified to be powered on is that an internal power supply of the heterogeneous computing module is not opened to a user. In a case that an external IO power supply is powered on first, current backflow or a functional abnormality may occur in IO of a core module. Therefore, the heterogeneous computing module outputs an external control signal to notify power on time to a power supply module except a power supply module that supplies power to the heterogeneous computing module.

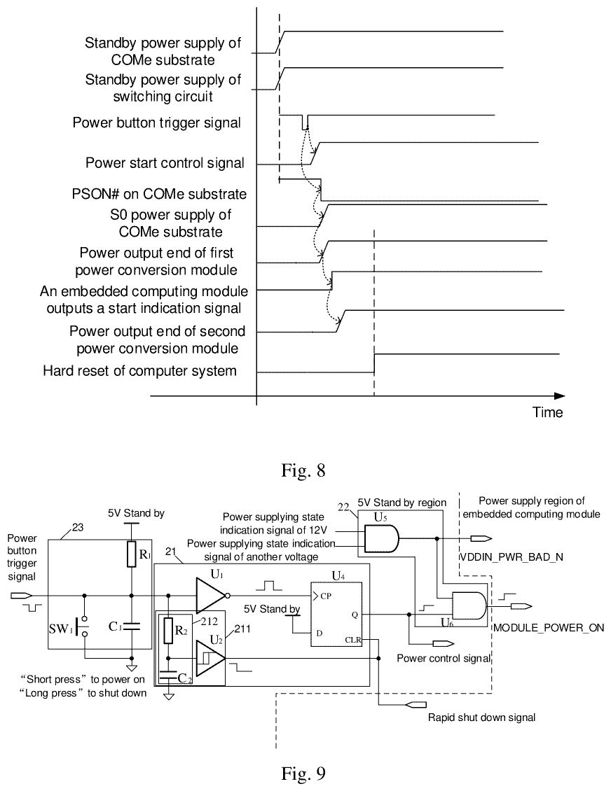

FIG. 8 is a power on start sequence chart according to the present disclosure. As shown in FIG. 8, the horizontal axis represents time, and the vertical axis represents a voltage of a signal or a voltage of a port. In state S5, standby power supplies for a COMe substrate and a switching circuit are ready. When a power switch button is pressed, a power button trigger signal (PWRBTN #) is generated. The switching circuit outputs a power start control signal (S3 # or pseudo S3 # signal) and pulls down a PSON # signal on the COMe substrate. An S0 power supply (a power supply) of the COMe substrate is powered on and is supplied to the embedded computing module through the first power conversion module. The embedded computing module then outputs a start indication signal to notify the S0 power supply (i.e. the second power conversion module) of the switching circuit to be powered on (in this way, it ensures that an external IO power supply will not cause backflow to a core module). At this time, supplying of power to a computer system is completed and then hard reset (System_RST #) and program start processes of the computer system will be carried out.

The embedded computing module switching circuit can generate a power control signal corresponding to a power button trigger signal by using the trigger control module to monitor the power button trigger signal (a heterogeneous computing module does not output a power control signal). In a case that the power button trigger signal indicates power on, the corresponding power control signal can be transmitted through the power control line to control the power supply to start to supply power to the power supplying cable. The first power conversion module can then convert a voltage on the power supplying cable and provide a converted voltage to the embedded computing module, and then by monitoring a power supplying state of the first power conversion module, the trigger control module can generate a corresponding start control signal in a case that the power supplying state of the first power conversion module is normal, to drive the embedded computing module to start, so that a power on control mode for an X86 computer can be compatible with a heterogeneous computing module.

In an embodiment, FIG. 9 is a schematic structural diagram III of a trigger control module according to the present disclosure. For a heterogeneous computing module A, the heterogeneous computing module A requires external power of 12V and 5V. As shown in FIG. 9, after power supplying is normal, a power supplying state monitoring signal (VDDIN_PWR_BAD_N) in FIG. 9 is output to a power supplying state monitoring port of the heterogeneous computing module A. After being normally supplied with external power and receiving a start control signal (MODULE_POWER_ON) signal, the heterogeneous computing module A starts and outputs a start indication signal (CARRIOR_PWR_ON) to enable the second power conversion module of the switching circuit power on (this step is that the an internal power supply of the heterogeneous computing module is not opened to a user. If an external IO power supply is powered on first, current backflow or a functional abnormality may occur in IO of a core module), and start of the heterogeneous computing module A is finally completed.

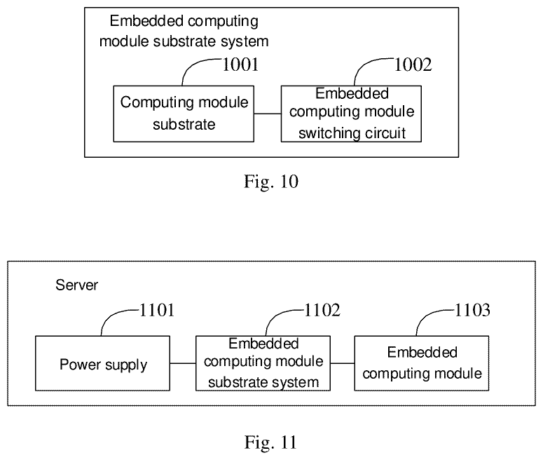

FIG. 10 is a schematic structural diagram of an embedded computing module substrate system according to the present disclosure. As shown in FIG. 10, the present disclosure further provide an embedded computing module substrate system (or referred to as COMe substrate system), including: a computing module substrate 1001 and any one of the above embedded computing module switching circuit 1002.

FIG. 11 is a schematic structural diagram of a server according to the present disclosure. As shown in FIG. 11, the present disclosure further provides a server, including: a power supply 1101, an embedded computing module 1103, and any one of the above embedded computing module substrate system 1102.

The apparatus embodiment described above is only schematic. The units described as separate parts may or may not be physically separate, and parts displayed as units may or may not be physical units, may be located in one position, or may be distributed on a plurality of network units. Some or all of the modules are selected according to actual needs to achieve the objective of the solution of this embodiment. Those of ordinary skill in the art can understand and implement the present disclosure without creative work.

Through the description of the above implementations, those skilled in the art can clearly understand that the implementations can be implemented by relying on software and essential general-purpose hardware platforms, or certainly, by relying on hardware. Based on such an understanding, the technical solutions essentially, or the part contributing to the related technology, may be presented in the form of a software product. The computer software product can be stored in a non-volatile readable storage medium, such as a read only memory/random access memory (ROM/RAM), a magnetic disk, or a compact disc, including several instructions to enable a computer device (which may be a personal computer, a server, a network device, or the like) to perform methods described in the embodiments or some parts of the embodiments.

It should be noted that, the foregoing embodiments are merely intended to describe the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to partial technical features thereof. However, these modifications or replacements do not make the essence of the corresponding technical solutions depart from the spirit and scope of the technical solutions of the various embodiments of the present disclosure.

1. An embedded computing module switching circuit, comprising a first power conversion module and a trigger control module,
wherein an input end of the first power conversion module is electrically connected to a power supplying cable; a power output end of the first power conversion module is electrically connected to a power end of the embedded computing module;
a power end of the trigger control module is electrically connected to a standby power supply cable; a first output end of the trigger control module is electrically connected to a power control line; a second output end of the trigger control module is electrically connected to a start control port of the embedded computing module;
the trigger control module is configured to:
output a power control signal to the first output end and output a start control signal to the second output end, by monitoring a power button trigger signal and monitoring a power supplying state of the first power conversion module; the power control signal is used for instructing a power supply to start to supply power or stops supplying power to the power supplying cable; and the start control signal is used for instructing the embedded computing module to start.

2. The embedded computing module switching circuit according to claim 1, wherein the trigger control module comprises a trigger signal monitoring submodule and a start control submodule;
an input end of the trigger signal monitoring submodule is electrically connected to a first end of a power button; a second end of the power button is grounded; an output end of the trigger signal monitoring submodule is electrically connected to an input end of the start control submodule; an output end of the start control submodule is electrically connected to the start control port of the embedded computing module;
the trigger signal monitoring submodule is configured to:
monitor the power button trigger signal; and
in a case that it is determined that the power button trigger signal indicates power on, output a power start control signal, wherein the power start control signal is used for instructing the power supply to start to supply power to the power supplying cable;
the start control submodule is configured to:
monitor the power supplying state of the first power conversion module; and
in a case that it is confirmed that the power start control signal has been received and the power supplying state of the first power conversion module is normal, output the start control signal, wherein the start control signal is used for instructing the embedded computing module to start.

3. The embedded computing module switching circuit according to claim 2, wherein the trigger signal monitoring submodule comprises: an inverter and a target flip-flop;
an input end of the inverter is electrically connected to a first end of the power button; an output end of the inverter is electrically connected to a first input end of the target flip-flop; a second input end of the target flip-flop is electrically connected to a power end of the target flip-flop; an output end of the target flip-flop is electrically connected to the input end of the start control submodule;
the target flip-flop is configured to: monitor a rising edge signal through the first input end, and output the power start control signal in a case that it is determined that the rising edge signal has been received; and a level of the power start control signal is the same as a level of the second input end of the target flip-flop.

4. The embedded computing module switching circuit according to claim 3, wherein the trigger signal monitoring submodule further comprises: a shutdown trigger signal monitoring unit; an input end of the shutdown trigger signal monitoring unit is electrically connected to the first end of the power button; an output end of the shutdown trigger signal monitoring unit is electrically connected to a clear end of the target flip-flop;
the shutdown trigger signal monitoring unit is configured to:
monitor the power button trigger signal; and
in a case that it is determined that the power button trigger signal indicates power off, output a clear control signal, wherein the clear control signal is used for indicating resetting on the output end of the target flip-flop; and
the target flip-flop is further configured to:
in a case that it is determined that the clear control signal has been received, output a power stop control signal, wherein a level of the power stop control signal is a ground level.

5. The embedded computing module switching circuit according to claim 4, wherein the shutdown trigger signal monitoring unit comprises: a low-pass filter and a Schmitt buffer;
an input end of the low-pass filter is electrically connected to the first end of the power button; an output end of the low-pass filter is electrically connected to an input end of the Schmitt buffer; and an output end of the Schmitt buffer is electrically connected to the clear end of the target flip-flop.

6. The embedded computing module switching circuit according to claim 5, wherein the low-pass filter comprises: a first resistor and a first capacitor;
a first end of the first resistor is electrically connected to the first end of the power button; a second end of the first resistor is electrically connected to a first end of the first capacitor and the input end of the Schmitt buffer; and a second end of the first capacitor is grounded.

7. The embedded computing module switching circuit according to claim 4, wherein the clear end of the target flip-flop is electrically connected to a power-off control line, and the power-off control line is configured to transmit the clear control signal.

8. The embedded computing module switching circuit according to claim 3, wherein the target flip-flop is a D flip-flop, and the D flip-flop is in a positive edge triggering mode.

9. The embedded computing module switching circuit according to claim 2, wherein the start control submodule comprises: a first AND gate unit and a second AND gate unit;
power supplying state indication ports of the first power supply conversion module are respectively electrically connected to corresponding input ends of the first AND gate unit, and one power supplying state indication port is configured to indicate a power supplying state of a supply voltage;
an output end of the first AND gate unit is electrically connected to a first input end of the second AND gate unit; a second input end of the second AND gate unit is electrically connected to an output end of the trigger signal monitoring submodule; an output end of the second AND gate unit is electrically connected to a start control port of the embedded computing module; a level of the power start control signal is used for representing logic 1;
the first power conversion module is configured to: in a case that power supplying of a target supply voltage is normal, instruct a port to output a logic high level through a target power supplying state, or in a case that the power supplying of the target supply voltage fails, instruct a port to output a logic low level through the target power supplying state;
the target supply voltage is any one of supply voltages supported by the first power conversion module; the logic high level is used for representing logic 1; and the logic low level is used for representing logic 0.

10. The embedded computing module switching circuit according to claim 9, wherein the output end of the first AND gate unit is electrically connected to a power supplying state monitoring port of the embedded computing module.

11. The embedded computing module switching circuit according to claim 1, wherein the trigger control module comprises: a target micro control unit (MCU);
a first output end of the target micro control unit is electrically connected to the power control line; a second output end of the target micro control unit is electrically connected to the start control port of the embedded computing module;
the target micro control unit is configured to:
monitor the power button trigger signal and monitor the power supplying state of the first power conversion module;
in a case that it is determined that the power button trigger signal indicates power on, output a power start control signal to the power control line, wherein the power start control signal is used for instructing the power supply to start to supply power to the power supplying cable;
in a case that it is confirmed that the power start control signal has been received and the power supplying state of the first power conversion module is normal, output the start control signal to the embedded computing module, wherein the start control signal is used for instructing the embedded computing module to start.

12. The embedded computing module switching circuit according to claim 11, wherein the first input end of the target micro control unit is electrically connected to a first end of the power button; a second end of the power button is grounded; and the target micro control unit is configured to:
monitor the power button trigger signal based on a level of the first end of the power button.

13. The embedded computing module switching circuit according to claim 11, wherein power supplying state indication ports of the first power conversion module are respectively electrically connected to corresponding input ends of the target micro control unit, and one power supplying state indication port is configured to indicate a power supplying state of a supply voltage;
the first power conversion module is configured to: in a case that power supplying of a target supply voltage is normal, instruct a port to output a logic high level through a target power supplying state, or in a case that the power supplying of the target supply voltage fails, instruct a port to output a logic low level through the target power supplying state;
the target micro control unit is configured to:
monitor levels of the power supplying state indication ports, and monitor the power supplying state of the first power conversion module;
the target supply voltage is any one of supply voltages supported by the first power conversion module; the logic high level is used for representing logic 1; and the logic low level is used for representing logic 0.

14. The embedded computing module switching circuit according to claim 13, wherein a third output end of the target micro control unit is electrically connected to a power supplying state monitoring port of the embedded computing module; and the target micro control unit is further configured to:
output a power supplying state indication signal to the embedded computing module, by monitoring the power supplying state of the first power conversion module.

15. The embedded computing module switching circuit according to claim 11, wherein the target micro control unit is further configured to:
in a case that it is determined that the power button trigger signal indicates power off, output a power stop control signal through the first output end, wherein the power stop control signal is used for instructing the power supply to stop supplying power to the power supplying cable;
or, wherein a second input end of the target micro control unit is electrically connected to a power-off control line, and the target micro control unit is further configured to:
in a case that it is determined that the power-off control signal has been received, output a power stop control signal through the first output end, wherein the power stop control signal is used for instructing the power supply to stop supplying power to the power supplying cable.

16. (canceled)

17. The embedded computing module switching circuit according to claim 1, wherein the trigger control module further comprises: a linear voltage regulator, wherein the linear voltage regulator is configured to: step down a supply voltage on the standby power supply cable and provide a stepped-down supply voltage to a target load in the trigger control module;
or, wherein the trigger control module further comprises: a trigger signal generation submodule, wherein the trigger signal generation submodule comprises a power button, a second resistor, and a second capacitor;
a first end of the second resistor is electrically connected to the standby power supply cable; a second end of the second resistor is electrically connected to a first end of the power button and a first end of the second capacitor; and a second end of the power button and a second end of the second capacitor are grounded.

18. (canceled)

19. The embedded computing module switching circuit according to claim 1, wherein the first power conversion module comprises a plurality of direct-current power conversion units; the direct-current power conversion units are configured to: convert supply voltages on the power supplying cable and provide the converted supply voltages to the embedded computing module; and the converted supply voltages provided by different direct-current power conversion units are not the same.

20. The embedded computing module switching circuit according to claim 1, further comprising: a second power conversion module, an input-output interface level conversion module, and an interface type conversion module,
wherein an input end of the second power conversion module is electrically connected to the power supplying cable; a power output end of the second power conversion module is electrically connected to the power end of the input-output interface level conversion module and a power end of the interface type conversion module;
a control port of the second power conversion module is electrically connected to an output end of the embedded computing module; and
the second power conversion module is configured to: receive, through the control port, a start indication signal transmitted by the embedded computing module, and in a case that the start indication signal has been received, start power supplying to the input-output interface level conversion module and the interface type conversion module.

21. An embedded computing module substrate system, comprising: a computing module substrate and an embedded computing module switching circuit, wherein the embedded computing module switching circuit comprises:
a first power conversion module and a trigger control module,
wherein an input end of the first power conversion module is electrically connected to a power supplying cable; a power output end of the first power conversion module is electrically connected to a power end of the embedded computing module;
a power end of the trigger control module is electrically connected to a standby power supply cable; a first output end of the trigger control module is electrically connected to a power control line; a second output end of the trigger control module is electrically connected to a start control port of the embedded computing module;
the trigger control module is configured to:
output a power control signal to the first output end and output a start control signal to the second output end, by monitoring a power button trigger signal and monitoring a power supplying state of the first power conversion module; the power control signal is used for instructing a power supply to start to supply power or stops supplying power to the power supplying cable; and the start control signal is used for instructing the embedded computing module to start.

22. A server, comprising: a power supply, an embedded computing module, and an embedded computing module substrate system, the embedded computing module substrate system comprises: a computing module substrate and an embedded computing module switching circuit, wherein the embedded computing module switching circuit comprises:
a first power conversion module and a trigger control module,
wherein an input end of the first power conversion module is electrically connected to a power supplying cable; a power output end of the first power conversion module is electrically connected to a power end of the embedded computing module;
a power end of the trigger control module is electrically connected to a standby power supply cable; a first output end of the trigger control module is electrically connected to a power control line; a second output end of the trigger control module is electrically connected to a start control port of the embedded computing module;
the trigger control module is configured to:
output a power control signal to the first output end and output a start control signal to the second output end, by monitoring a power button trigger signal and monitoring a power supplying state of the first power conversion module; the power control signal is used for instructing a power supply to start to supply power or stops supplying power to the power supplying cable; and the start control signal is used for instructing the embedded computing module to start.
